(19) United States
(12) Patent Application Publication
(10) Pub. No.: US 2004/0018859 A1
(43) Pub. Date: Jan. 29, 2004

(54) System and method for menu selection in telephone

(76) Inventor: Michael Vines, San Diego, CA (US)

Correspondence Address: Qualcomm Incorporated, Patents Department, 5775 Morehouse Drive, San Diego, CA, 92121-1714, US

(21) Appl. No.: 10/209,528

(22) Filed: Jul. 29, 2002

(51) Int. Cl. H04B 1/38

(52) U.S. Cl. 455/566

(57) ABSTRACT

Only items in a menu list in a wireless telephone are displayed that begin with a letter represented by a number key that is manipulated by a user when the telephone is in a menu mode. The user may manipulate a second number key to further winnow the displayed items to only those that have second letters beginning with one of the letters represented by the second-manipulated key, and so on.

### FIELD OF THE INVENTION

The present invention relates generally to communication systems, and more particularly to selecting an item from a menu displayed on a wireless communication device.

### BACKGROUND OF THE INVENTION

Wireless communication devices have become ubiquitous. Devices such as wireless telephones include so-called mobile station modems (MSM) that essentially are wireless communication computers which, like all digital computers, execute software to undertake the functions desired by the user.

Among the functions telephones, including wireless telephones, can undertake is displaying a menu of various options to the user. The menu might list security options, display options, mode options, and so on. In fact, dozens if not hundreds of options might be available.

The present invention critically observes that scrolling down a menu list until a desired item is observed by the user can be cumbersome and time consuming. This can be of particular importance to a person using a wireless telephone while at the same time doing something else that requires that the user not divert her eyes to the telephone for more than a very short period. Some telephones allow numbers to be correlated to menu items, but this requires a user to remember what the correlations are, something that grows impractical with larger menu lists. Having made these critical observations, the present invention is provided.

### SUMMARY OF THE INVENTION

A method for menu item selection using a telephone having number keys includes receiving a first signal generated when a first number key representing plural letters is manipulated. Only first items from a menu stored in the telephone that have first letters identical to any one of the letters represented by the first number key are displayed.

In a preferred embodiment, the telephone is a wireless telephone, and the method further includes providing a way for the user to further winnow the list of items that are displayed. Specifically, the preferred method includes receiving a second signal that is generated when a second number key representing plural letters is manipulated. Only first items that have second letters beginning with any one of the letters represented by the manipulated second number key are then displayed. The second number key can be the same as or different from the first number key. Continuing with present preferred principles, if desired a third number key representing plural letters can be manipulated to further eliminate menu items.

In another aspect, a wireless communication device has plural number keys at least some of which represent plural letters. The communication device also includes a menu of items, and a display. A processor causes the display to present, in a menu mode, only items in the menu having at least a first letter that is the same as one of the letters represented by a first manipulated one of the number keys.

In yet another aspect, a wireless telephone includes display means and processor means causing the display means to display alphanumeric characters. Logic means are executed by the processor means for causing the display means to present only menu items in a menu mode beginning with letters represented by a first manipulated number key.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of a telephone; and

FIG. 2 is a flow chart of the present logic.

### DETAILED DESCRIPTION OF THE PREFERRED EMBODIMENT

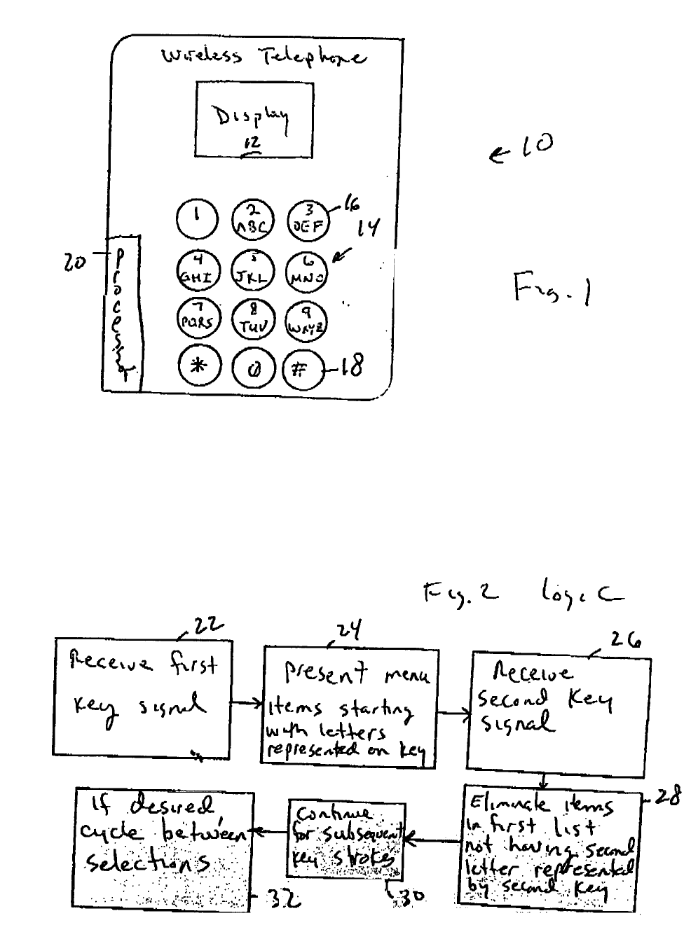

Referring initially to FIG. 1, a communication device is shown, generally designated 10, for facilitating computer data and/or voice communication in a communication network. The device 10 is configured as a telephone, and in a preferred implementation is a wireless communication device, although the principles advanced herein can apply to landline telephones as well.

In one non-limiting preferred implementation the device 10 is a code division multiple access (CDMA) mobile station that, e.g., uses cdma2000, cdma2000 3×, or cdma2000 high data rate (HDR) principles, or other CDMA principles. In one non-limiting embodiment the wireless communication device 10 is a mobile telephone made by Kyocera, Samsung, or other manufacturer that uses Code Division Multiple Access (CDMA) principles and CDMA over-the-air (OTA) communication air interfaces. The present invention, however, applies to other mobile stations such as laptop computers, wireless handsets or telephones, data transceivers, or paging and position determination receivers. The wireless communication device 10 can be hand-held or portable as in vehicle-mounted (including cars, trucks, boats, planes, trains), as desired. However, while wireless communication devices are generally viewed as being mobile, it is to be understood that the present invention can be applied to “fixed” units in some implementations. Also, the present invention applies to data modules or modems used to transfer voice and/or data information including digitized video information, and may communicate with other devices using wired or wireless links. Further, commands might be used to cause modems or modules to work in a predetermined coordinated or associated manner to transfer information over multiple communication channels. Wireless communication devices are also sometimes referred to as user terminals, mobile stations, mobile units, subscriber units, mobile radios or radiotelephones, wireless units, or simply as “users” and “mobiles” in some communication systems. It is to be understood that the present invention applies equally to other types of wireless devices including without limitation GSM devices, time division multiple access (TDMA) systems, etc.

FIG. 1 shows that the communication device 10 includes a display 12 such as but not limited to a flat panel display, for displaying, e.g., menu lists. Also, the communication device 10 includes a key area 14 on which are mounted number keys 16 in accordance with principles known in the art. Non-number keys 18, such as a star key and a pound sign key, may also be provided.

In the embodiment shown in FIG. 1, in addition to the numbers they represent, the number keys 16 represent letters according to the following convention. “2” represents a, b, and c, “3” represents d, e, and f, “4” represents g, h, and i, “5” represents j, k, and l, “6” represents m, n, and o, “7” represents p, q, r, and s, “8” represents t, u, and v, and “9” represents w, x, y, and z. It is to be understood that other key layouts and other number-to-letter correlations can be used. In any case, at least some of the number keys represent one numeral and two or more letters.

FIG. 2 shows the logic by which rapid menu item selection is facilitated by the present invention. The logic shown in FIG. 2 is executed by a processor 20, schematically shown in FIG. 1, within the communication device 10. Initially, a menu is caused to be presented on the display 12 in accordance with principles known in the art, e.g., when the communication device 10 has been configured by the user to be in a menu display mode.

Then, as indicated at block 22, a first key signal is received that is generated when a user depresses or otherwise manipulates one of the number keys 16. In the preferred embodiment, depressing or otherwise manipulating any number key 2-9 inputs, to the processor 20, all of the letters that are represented by the manipulated key. Accordingly, at block 24 the processor 20 causes only menu items to be displayed that start with one of the letters represented by the manipulated key.

If the user so desires, she can manipulate a second number key at block 26 to further winnow the list. Accordingly, at block 28 the processor 20 eliminates items on the displayed list that do not have second letters that are the same as one of the letters represented by the second-manipulated key (which can be the same key as the first-manipulated key). Block 30 indicates that if desired, the user can manipulate subsequent number keys to further winnow the list that is presented in accordance with principles discussed above. Block 32, on the other hand, simply indicates that if desired, the user can manipulate arrow keys to scroll through whatever items remain.

While the particular SYSTEM AND METHOD FOR MENU SELECTION IN TELEPHONE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. '112, sixth paragraph, unless the element is expressly recited using the phrase “means for” or, in the case of a method claim, the element is recited as a “step” instead of an “act”.

What is claimed is:

1. A method for menu item selection using a telephone having number keys thereon, comprising:
receiving a first signal generated when a first number key representing plural letters is manipulated; and
displaying only first items from a menu stored in the telephone having first letters identical to any one of the letters represented by the first number key.

2. The method of claim 1, wherein the telephone is a wireless telephone.

3. The method of claim 2, further comprising:
receiving a second signal generated when a second number key representing plural letters is manipulated; and
displaying only first items having second letters beginning with any one of the letters represented by the manipulated second number key.

4. The method of claim 3, wherein the second number key is the same as the first number key.

5. The method of claim 3, wherein the second number key is different from the first number key.

6. The method of claim 3, further comprising:
receiving a third signal generated when a third number key representing plural letters is manipulated; and
displaying only first items having second letters beginning with any one of the letters represented by the manipulated second number key and third letters beginning with any one of the letters represented by the manipulated third number key.

7. A wireless communication device, comprising:
plural number keys at least some of which represent plural letters;
at least one menu of items;
at least one display; and
at least one processor causing the display to present, in a menu mode, only items in the menu having at least a first letter that is the same as one of the letters represented by a first manipulated one of the number keys.

8. The wireless communication device of claim 7, wherein the user can manipulate a second number key when in the menu mode and in response thereto the processor causes the display to present only the subset of the items displayed after the first one of the manipulated keys is manipulated that have second letters that are the same as one of the letters represented by the second number key.

9. The wireless communication device of claim 8, wherein the second number key is the same as the first number key.

10. The wireless communication device of claim 8, wherein the second number key is different from the first number key.

11. A wireless telephone, comprising:
display means;
processor means causing the display means to display at least alphanumeric characters; and
logic means executed by the processor means for causing the display means to present only menu items in a menu mode beginning with letters represented by a first manipulated number key.

12. The telephone of claim 11, wherein a user can manipulate a second number key and the logic means causes the display means to present only the subset of the items displayed after the first one of the manipulated keys is manipulated that have second letters that are the same as one of the letters represented by the second number key.

13. The telephone of claim 12, wherein the second number key is the same as the first number key.

14. The telephone of claim 8, wherein the second number key is different from the first number key.
